(19) United States
(12) Patent Application Publication
(10) Pub. No.: US 2006/0100927 A1
(43) Pub. Date: May 11, 2006

(54) Prepaid payment card that can be instantly recharged remotely by coupon

(76) Inventor: Alexandre Sam Zormati, New Rochelle, NY (US)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 11/006,833

(22) Filed: Dec. 8, 2004

Related U.S. Application Data
(60) Provisional application No. 60/522,822, filed on Nov. 10, 2004.

(51) Int. Cl. G06Q 30/00

(52) U.S. Cl. 705/14

(57) ABSTRACT

The invention pertains to a payment method by prepaid bankcard provided by a financial intermediary of a transaction with a merchant including the recharging steps of modifying on the management server the information relative to the balance available to the holder of the bankcard, wherein the recharging is implemented via a prepaid coupon with which is associated a unique identification number and to which corresponds a predefined amount; the management server moreover includes a database of unique coupon numbers as well as the validity status and the value corresponding to the coupons; and in which the recharging steps include a step of transmission of the coupon identifier and the bankcard identifier to the management server; a step of verification by the management server of the validity of the received coupon identifier; a step of determination of the numeric value of the amount associated with the coupon; a step of modification of the validity status of the consumed coupon; and a step of updating the account balance of the bankcard.

The present invention pertains to the field of rechargeable payment cards.

The present invention pertains more specifically to a method, a prepaid coupon and a system for recharging prepaid bankcards usable on a comprehensive interbank network.

Rechargeable bankcard solutions already exist. The present invention proposes a simplification of the recharging means and a speeding up of the recharging process by the use of prepaid coupons.

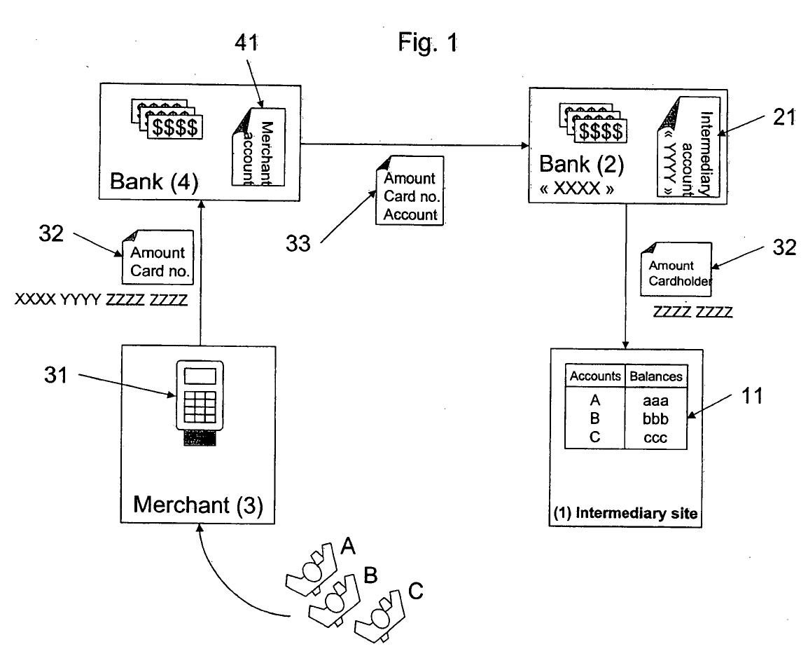

In certain forms of banking systems, especially in the United States, a financial intermediary manages a group of virtual bank accounts associated with payment cards and holders. FIG. 1 illustrates the classic payment schema in such a system.

The financial intermediary manages a group of accounts (11) belonging to holders (A, B, C, . . . ). The intermediary has available a personal account (21) established in a bank (2).

During a payment operation by card of a holder (A, B, C, . . . ) with a merchant (3), the payment terminal (EPT) (31) transmits to the merchant's bank (4) the information relative to the transaction (32), i.e., the amount of the transaction and the bankcard number.

The bank (4) credits the merchant's account (41) in the amount of the transaction then transmits to the bank (2) associated with the payment card the transaction information (amount, card number and account number of the merchant to be credited).

The card number is composed of a series of digits “XXXX YYYY ZZZZ ZZZZ”. The four first digits “XXXX” serve, e.g., to identify the intermediary's bank for the transmission (33). The four following digits “YYYY” enable identification of the intermediary's account within the bank (2). All of the intermediary's clients have available a payment card the first digits “XXXX YYYY” of which are identical so as to allow the implementation of transactions involving the intermediary's bank account (21).

The bank (2) receiving the transaction information (33) (amount deducted from card “XXXX YYYY ZZZZ ZZZZ” to the benefit of the account (41)) debits the account “YYYY” and informs (34) the intermediary's site of the transaction implemented by the client “ZZZZ ZZZZ”.

The intermediary updates in the database the balance of the account associated with the card “ZZZZ ZZZZ”. The accounts of the payment cardholders are uniquely virtual: there does not exist in a bank an account specific to each cardholder but rather a single account (21) belonging to the intermediary, the cardholders' accounts (11) being managed in a virtual manner by the financial intermediary.

The present invention lies within the framework in such a context for which the payment cards are rechargeable prepaid cards.

Such prepaid bankcards exist. In the United States, especially, it is possible to replenish a virtual account by sending a check to the financial intermediary which will credit within an elapsed time of three to seven days the virtual account associated with the issuer of the check. Such a solution cannot be satisfactory for a cardholder who has an immediate need for credit on his account.

Also known in the state of the art from international patent application WO 03/079 159 (Euronet Worldwide) is a method and a system of payment by prepaid account cards and replenishing of these prepaid accounts. The recharging of the account associated with the card (the term “recharging of the card” will be employed below with the same meaning) is performed by the intermediary of terminals available in a large number of points of sale. However, this solution does not enable remote recharging of the card because the card must be presented in the terminal in order to implement its replenishment.

Also known from the American patent U.S. Pat. No. 6,473,500 (MasterCard) and the PCT patent application WO 01/009/853 (Software.com) are other methods of recharging prepaid bankcards. However, all of these proposed solutions also require the presence of a terminal.

The present invention has the intention of resolving the drawbacks of the prior art by proposing a method, a prepaid coupon and a system for recharging the prepaid bankcard (i.e., recharging the associated account) by the intermediary of a prepaid coupon available from a large number of resellers on all of the sites at which the interbank network to which the card belongs is installed.

The clients purchase, from the financial intermediary or their bank which belongs to the worldwide common interbank network, a prepaid payment card, e.g., a Visa or MasterCard (trademarks) card, which can be recharged by scratch-off coupons sold in a network of approved automated dispensing machines. The clients recharge their cards in the same manner as the coupons sold by the mobile telephone system operators. The recharging of the payment card then instantly credits the client's payment card by a method proprietary to the server of the financial intermediary and which gives the recharging information to the bank processors and to the worldwide interbank network (Visa, MasterCard) at the same time. The payment card is thereby “seen” with its new balance credited by the payment terminals of the interbank network. It is thus no longer necessary to use specific financial institutions or banks which resolves the problems of those people who no longer have access rights to bank accounts or others searching for such services. The holder of the payment card can implement cash withdrawals on any automated dispensing machine served by the Visa/MasterCard interbank network while implementing payments/purchases using this card which is accepted by all of the merchants of the network.

Such a prepaid payment card rechargeable by coupons provides a large number of advantages:

it is not necessary to open a bank account;

the suspension of banking privileges disappears because all that needs to be done is to replenish one's account in order to have available a practical mode of payment whereas the suspension of banking privileges prevents an individual from having access to such a practical means;

the card facilitates worldwide instantaneous money transfers to the benefit of a relation to whom the cardholder would have made available a clone card;

remunerate the employees of a company by means of prepaid coupons instead of issuing checks or implementing money transfers which involve expenses;

a monitoring of these expenditures and security in the case of loss of the card (withdrawal limited to the available balance);

traditional use on the entire interbank network of the Visa and MasterCard type (trademarks).

The present invention also proposes to provide other advantages:

remote telephonic (voice server) recharging or via the internet;

instantaneous recharging.

Known in the prior art and notably from American patent U.S. Pat. No. 6,375,073 (Swisscom) and international patent application WO 03/019 926 (Sicap) are data card recharging coupons. These cards are generally intended for use in the mobile telephone environment in order to recharge in telephonic units prepaid mobile telephone accounts. Generally speaking, the recharging coupons known in the prior art compensate the purchase cost by the assignment of units of which the data cards are constituted. Prepaid recharging coupons the compensation of which consists in the recovery of the initial numeric value of the coupon on an account have not been implemented in the prior art.

For this purpose, the invention pertains in its broadest sense to a payment method by prepaid bankcard provided by a financial intermediary of a transaction with a merchant comprising:
a step of transmission to a management server by the merchant's bank server of a request comprising at least the amount of the transaction and an identifier of the bankcard, said transmission being implemented via the intermediary's bank server;
a step of verification and modification of the status of the account associated with the bankcard identifier by the management server, this server comprising a database of the bankcard identifiers and the balance status of the accounts associated with said bank cards;
a step of transmission of the payment authorization to said merchant (EPT or automated dispensing machine);
recharging steps consisting of modifying on the management server the information relative to the available balance of the bankcard holder;

method in which:
recharging is implemented via the intermediary of a prepaid coupon with which is associated a unique identification number and to which corresponds a predefined amount;
said management server moreover comprises a database of unique coupon numbers as well as the validity status and the value corresponding to the coupons;

and in which said recharging steps comprise:
a step of transmission of said coupon identifier and said bankcard identifier to said management server;
a step of verification by said management server of the validity of the received coupon identifier;
a step of determination of the numeric value of the amount associated with the coupon;
a step of modification of the validity status of the consumed coupon;
a step of updating the account balance of said bankcard.

In one mode of implementation, said recharging steps moreover comprise, subsequent to said step of updating the account balance, a step of updating in the interbank network to which the prepaid bankcard belongs the available balance for said recharged bankcard.

This step notably means that the recharging is effective instantaneously because the card is credited in the processing cycle on the interbank network.

According to one mode of implementation said financial intermediary has available a bank account on said intermediary's bank server and said method furthermore comprises:

a step of selling at least one coupon;
a step of crediting on said bank account the amount of the sold coupons;
a step of periodic debiting (daily, weekly or monthly debiting) from said bank account of the amounts paid by the bankcards provided by said financial intermediary.

According to one mode of implementation, said step of transmission of said coupon identifier and said bankcard identifier to said management server is implemented via the intermediary of an interactive voice server.

The voice server enables easy remote and anonymous access.

According to one particular mode of implementation, the transmission of said coupon identifier and/or said bankcard identifier to said voice server is a sound transmission.

This transmission ensures the secrecy of the codes and the card numbers as well as a rapid input thereof.

According to a variant, the transmission of said coupon identifier and/or said bankcard identifier to said voice server consists of inputting the digits constituting the unique identifier of the coupon and/or the bankcard.

Said step of transmission of said coupon identifier and said bankcard identifier to said management server is especially implemented by the intermediary of a secure internet site.

The use of a secure internet site ensures a worldwide accessibility as well as the security of the implemented transactions.

The invention also pertains to a recharge coupon for the implementation of the method comprising a unique identification number and covering means to be scratched off that hide said unique number.

In one mode of implementation, said coupon moreover comprises means for the sound transmission of said unique number.

Said number especially comprises between 10 and 16 digits.

Said number especially comprises 12 digits.

The invention also pertains to a system of payment by prepaid bankcard for the implementation of said method, comprising:
an international interbank network comprising a multiplicity of terminals;
a multiplicity of prepaid bankcards provided by a financial intermediary and belonging to said interbank network;
a multiplicity of prepaid coupons for recharging said bankcards according to one of claims 8 to 10;
a management server of said financial intermediary, said management server comprising a database of the unique coupon numbers as well as the validity status and the corresponding value of the coupons, and a database of the bankcard identifiers and the status of the available balance of the associated bankcards;
a bank server connected to the interbank network and to the management server, said bank server comprising a bank account of said financial intermediary credited by the amount of the coupons sold and debited periodically from the amounts paid by said payment cards.

In one mode of implementation, said system furthermore comprises a voice server connected to said management server and by which the user wishing to recharge his prepaid bankcard transmits the unique identifiers of his bankcard and the recharge coupon.

According to one particular mode of implementation, said system furthermore comprises an internet server connected to said management server and housing a secure internet site capable of implementing the operations of transmission of the unique identifiers of a prepaid bankcard and of a recharge coupon for the effective recharging of said bankcard.

Better understanding of the invention will be obtained from the description presented below for purely explanatory purposes of one mode of implementation of the invention with reference to the attached figures:

FIG. 1 illustrates the architecture of a known bank system of the prior art;

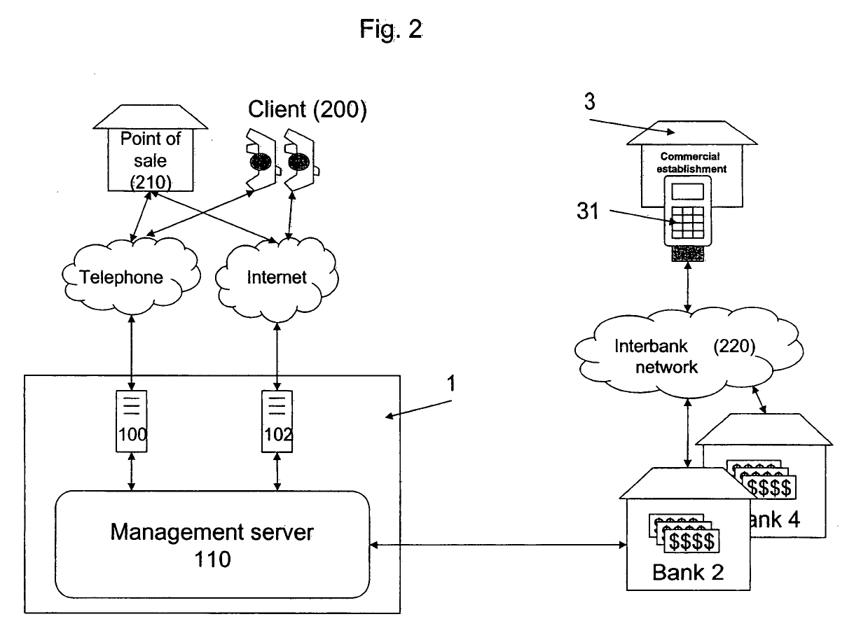

FIG. 2 illustrates the architecture of the system of recharging prepaid bankcards according to the present invention;

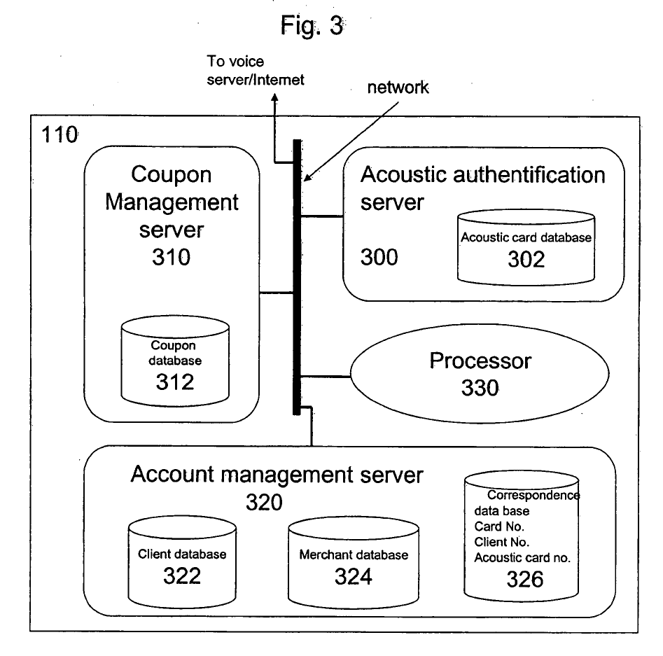

FIG. 3 is a modular representation of the management server of the recharging platform of the system of FIG. 2;

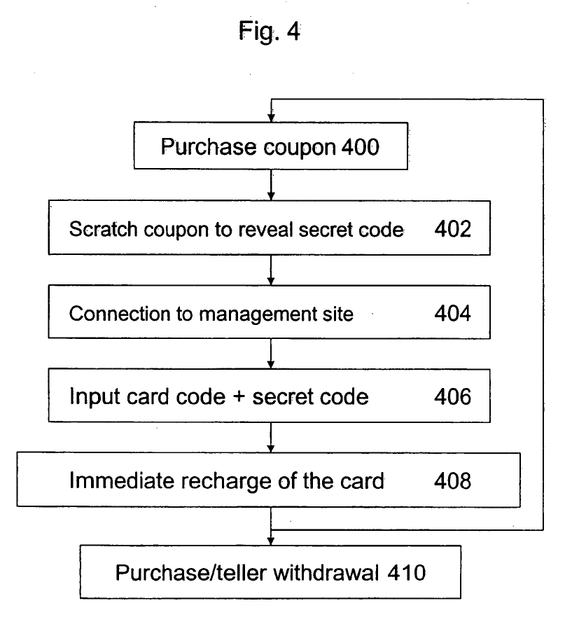

FIG. 4 is a flowchart representing the different steps of a process according to the present invention;

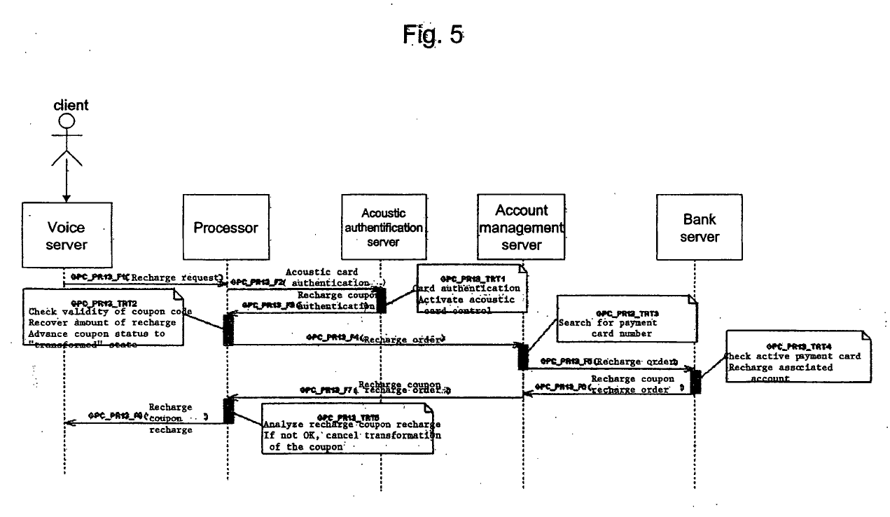

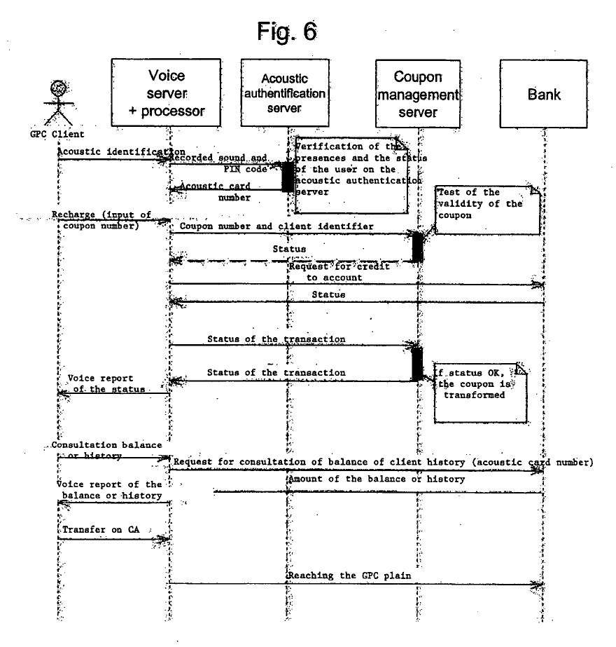

FIGS. 5 and 6 illustrate the information exchanges between different modules of the system during recharge operations; and

FIGS. 7 and 8 illustrate two modes of use of the present invention.

FIG. 2 represents an example of the platform for the implementation of the present invention.

A financial intermediary has available a technical platform (1) for the management of the prepaid payment cards and the coupons that it sells.

This platform is accessible via interactive voice server (100) or via http server (102) connected to the internet network. A management server (110) enables implementation of all of the operations to be discussed below.

A multiplicity of points of sale (210—tobacco stores, telephone stations, post offices, banks, etc.) and acquisition of payment cards and/or recharge cards for the clients (subscribers) (200) of the financial intermediary have access to the financial intermediary's platform (1) via the telephonic network or the internet.

The management server (110) is connected, preferably by a dedicated fixed link, to its bank (2) which belongs to the worldwide interbank network (220) of the e.g., Visa or MasterCard type (trademarks).

The clients thus can enter a large number of commercial establishments (3) all connected to the worldwide interbank network (220). The merchants' banks (4) are themselves connected to the interbank network in order to validate the transactions implemented by the merchants.

Payment Card

An initial phase allows the final client to acquire a prepaid payment card. In order to do this, the client can use a dedicated web site or a suitable paper form in order to provide his personal information such as last name, first name, address and the type of payment card desired.

The management server illustrated in FIG. 3 comprises an acoustic authentication server (300), a coupon management server (310), a middle office server for management of the clients' accounts (320) and a processor for the management operations (330).

The financial intermediary records the client's data in a dedicated client database (322) present in the account management server.

A payment card command is then generated by the intermediary to the partner bank (2). The partner bank assigns a unique payment card number.

In one mode of implementation, the payment card has, in addition to its unique number, means for authentication by random and unique acoustic signature. All known technology of the prior art can be employed. These authentication means are associated with a unique number N-N which is stored in a dedicated database (302).

In response, the bank (2) informs the intermediary of the creation of the payment card and communicates to the intermediary the unique numbers of the card and the authentication means. These numbers are also recorded in the database housed in the account management server: a client database (322) for the card number and a database (326) of correspondence between the different numbers associated with a client account and a payment card: payment card number, number N-N, client number (identifier internal to the intermediary's platform).

Upon receiving the payment card as well as the PIN codes for recharging and for use (e.g., for purchases and withdrawals) composed traditionally of four digits, the client activates the card in order to be able to benefit from the recharging services. This activation can, for example, be implemented by the transmission via a voice server (100) of the acoustic signature emitted by the card's authentication means and the recharge PIN code associated with the card. The management server then verifies the correspondence between these two values and, contingent on the results, activates the card.

These payment cards can then be used as traditional payment cards in all of the commercial establishments belonging to the worldwide interbank network: the regulations are applied to the universal terminals (31, FIG. 2) and according to the same process as for immediate debit payment cards. These cards also allow withdrawals via all types of automated dispensing machines: cash withdrawal is implemented via automated teller machines according to the same process as for immediate debit payment cards.

In one mode of implementation, the accounts associated with the prepaid cards cannot have negative balances, hence the name prepaid card, because the card must contain funds prior to a transaction. These cards are recharged via the intermediary of prepaid recharge coupons.

The recharge coupons

The recharge coupons are cards of credit card format comprising a unique identification number and a secret code protected by a scratch-off layer. The coupons have a predetermined value. These payment coupons can also contain acoustic identification means in the same manner as the prepaid payment cards and be personalized for advertising purposes. These (unique) authentication means are then means responding to the unique number for the identification of these coupons.

These prepaid recharge coupons are available and sold to clients possessing a prepaid payment card in all of the points of sale (210) in exchange for a numeric amount equivalent to the predetermined value of the coupon.

Following the step of manufacture of the coupons, the intermediary records in a coupon database (312) the numbers (identification number and secret code) of these coupons as well as the value associated with each coupon. The coupons have whole-number currency values, e.g., 50 euros, 100 euros, 500 euros, . . . , 50 dollars, 100 dollars, etc. This coupon database (312) is connected to the management processor (330), which itself interfaces with the financial intermediary's bank (2) and with the voice server (or internet server).

The coupon database (312) also has means, e.g., in the form of a flag (a Boolean field) indicating the active/inactive status of the coupons: in contrast to an active coupon, an inactive coupon cannot be credited to a prepayment card.

The coupons are thus sold via the intermediary of all of the points of sale (210). The funds collected during these sales are deposited to a specific account (21, FIG. 1) which will subsequently be used by the intermediary to compensate the banks of the merchants which implemented transactions with one of the prepaid cards.

Upon receiving the coupons, the points of sale activate all of these coupons so that they can be credited to the prepaid accounts when they are purchase by the clients of the financial intermediary. This activation can be implemented via the voice server (100), the point of sale identifying itself (e.g., with a card equipped with acoustic authentication means) and inputting the set of unique numbers of the coupons received for activation or the activation codes for the purchased coupons (a database of the activation codes of the coupons is then present on the coupon management server). The activation can be made secure and requires the use of specific coupon activation codes. These codes are recorded in a specific database (not shown) of the coupon management server (310).

In a similar manner, the point of sale or any other entity involved in the chain (e.g., financial intermediary) can block or cancel the activation of one or more recharge coupons. The flag present in the coupon database (312) is adapted for each of the coupons as a function of the request formulated by the requestor.

In this manner the coupons are available for sale and ready for recharging prepaid payment cards.

Method for Recharging the Prepaid Payment Card

With reference to FIG. 4, the method for the recharging of a prepaid payment card comprises a first step of purchasing (400) a prepaid coupon as described above at a point of sale of the tobacco store, post office, telephone station, etc. type belonging to the approved distribution network. The purchase is made in exchange for a sum of money equivalent to the predefined value of the coupon, this value being the amount that can be recharged on the prepaid payment card by means of this coupon.

This sale enables the automated dispensing machine to recover the funds paid in the purchase of the coupon from the financial intermediary. In this economic model, the money paid by the client who purchases a coupon is virtually stored in the bank account (21).

Once he has purchased the coupon, the client scratches off the protective layer from the secret code so as to reveal this code (402). This code is generally a numeric code composed of 10 to 20 digits, e.g., 10, 12, 14 or 16 digits. It is this code that confirms the uniqueness of the coupon.

In one particular mode of implementation, the purchased coupon does not have a secret code hidden by a scratch-off layer but rather means of acoustic authentication as mentioned above. These means also make it possible to ensure a unique identification of the coupon. Step 402 is not required in the process in this alternative.

In a variant, these two means (acoustic authentication and hidden secret code) are combined so as to, on the one hand, enable a rapid identification (acoustic) via a voice server and, on the other hand, to enable identification of the coupon when the acoustic identification server is not available (e.g., recharging via the internet).

The client then connects to the management server for recharging his prepaid card (404). This operation can be implemented via a telephone call to a voice server (100): the client calls the telephone number indicated on the recharge coupon and follows the instructions; or via a secure web site: the client connects to the financial intermediary's web site and proceeds to perform the various operations resulting in the recharging of the payment card.

When connected to the management server, the client identifies himself, e.g., by the payment card number, and inputs the secret code of the coupon in order to credit the card with the amount of the purchased coupon (406).

The server then proceeds to the recharging (408) of the account of the client associated with the payment card. This operation is implemented rapidly—on the order of seconds. Thus the funds are immediately available on the payment card.

The payment card the balance of which was credited can then be used for traditional purchase/withdrawal operations (410).

FIG. 5 illustrates the process of recharging a payment card by recharge coupon.

The client who had called the telephone number of the voice server (100) implements a recharge request by the purchased recharge coupon. In order to accomplish this, the client communicates to the management server (330) via the voice server:

the acoustic signature of the payment card “XXXX YYYY ZZZZ ZZZZ”,

the recharge PIN code of the payment card,

the secret code revealed by scratching the recharge coupon.

For example, the voice server asks the client to position his card on his telephone in order to play the audio authentication sequence. Once the signal has been correctly transmitted, the voice server asks the client to input his recharge PIN code. During the identification request, the voice server awaits the response by playing holding music. If the acoustic signal is not correct or if the recharge PIN code is invalid, the voice server again asks the client to identify himself. Three attempts at identification are permitted before the call is ended. In the case of malfunction of the transaction, the client can be transferred to a technical assistance platform.

The management processor (330) implements the request for authentication of the payment card with the authentication server (300) by communicating to it the recorded sound and recharge PIN code as well as the contextual data (time and date, etc.).

The server 300 implements the authentication of the card by comparing, by means of a software program, the received sound with the number recorded in the database 302 and verifies that the card with the transmitted number is indeed active (information also contained in the database). It then returns an authentication message containing the client number of the card and a successful authentication number. This client number is a unique number used internally on the financial intermediary's platform, e.g., of 5 digits. The client number can be the number N-N when this number is unique, or the unique number of the payment card, or any other number uniquely used for the client reference within the management platform. The correspondence between this client number and the various other numbers (payment number, number N-N) is stored in memory in the correspondences database (326).

The voice server then asks the client to input the coupon number that he has just revealed by scratching. A control of the length of the coupon number is performed by the voice server in order to avoid transaction errors. If the number is correct, the voice server sends a recharge request to the server. In the case of a correct credit, the SVI states the new balance and asks the client to hang up. Confirmation of the transaction by SMS is possible. In the case of an incorrect credit (input error of the coupon number, transaction incident), the voice server transfers the call to a call center.

Upon receiving the confirmation of authentication and of the coupon number, the management processor (330) checks the validity of this recharge coupon, recovers the value of the coupon and changes the status of the coupon to “transformed”. A coupon is considered to be transformed if when it was active it was used for crediting a payment card. A coupon is considered to be non-transformed if it is active and has not yet been used in the context of a recharge of a prepaid card. As illustrated by FIG. 6, the validity test of the coupon is implemented by the coupon management processor. This processor searches in its coupon database (312) for the data entry corresponding to the number of the transmitted coupon. Among other information, the data recorded in this database comprises:

coupon number,

corresponding value of the coupon,

currency,

active/inactive status,

date of expiration of validity.

In the case of absence, the coupon is considered to be invalid and the client is asked to re-input a number or to terminate the call. If the coupon number is in fact present, the processor verifies the active status of the coupon (if it is not active, e.g., because the coupon was stolen and rendered inactive, the recharge operation is aborted), the date of expiration of validity and recovers the value of the coupon. Finally, the data entry corresponding to the coupon number is made to be “transformed” so that the coupon number cannot permit another card recharge operation. This “transformation” can be simply implemented by the removal of the corresponding entry of the database 312.

Following this “transformation”, the processor emits an order to recharge the payment card by communicating to the account management server (320):

a transaction number,

the client number of the card,

the amount of the recharge,

the currency of the recharge.

The server comprises a first client database (322) comprising at least the fields:

personal information on the client (last name, first name, address, etc.),

active/inactive status.

unique number of the payment card,

balance of the associated account.

And a second database (326) of the correspondences between the payment card numbers and the client numbers of the means of acoustic authentication placed on the payment cards.

The account management server determines the payment card number by means of the transmitted client number (database 326) then credits the balance of the account associated with this card with the amount of recharging transmitted in the appropriate currency if the card has an active status.

The recharge order is then transmitted to the bank (2), which transmits to the interbank network the information such as that the payment card has a new balance. Since in certain interbank networks, a payment card transaction does not require verification of the status of the associated account but is based solely on the payment possibilities associated with the card, this transmission to the entire interbank network is important: it can thereby enable updating of the payment possibilities relative to the card.

By cascade, a return is implemented subsequent to the recharge order from the bank servers updating the interbank network to the voice server passing via the processor which validates the correct progression; if this is not the case, the “transformed” updating of the coupon is cancelled if the recharging was not implemented. The return messages contain:

transaction number,

client number of the payment card,

new account balance,

currency,

date of the expiration of the credit.

In order to cancel the “transformation”, the server moves the eligible coupon back to the status that preceded the transformed state. The changing of status of the coupons is stored in an archive. The archived data are the series number, the status, the date of status change, the reference of the point of sale and the identifier of the user who implemented the request.

Once the information has been input by the client, the authentication cycle, validation of the card and coupon, recharging of the account, transmission of the information onto the interbank network and the return of confirmation is estimated to take several seconds, essentially less than two seconds. The dimensioning of the network links, the processors, the cell formats of the transmitted data is defined such that the constraint of a cycle less than two seconds is respected up to peaks of eight million simultaneous recharges.

Other Functionalities

The voice server provides numerous other services: blockage of lost coupons/cards, balance consultation, information on the last account operations, transmission of the lost recharge/use PIN codes of a payment card and all other types of services.

The platform also comprises call centers for information, technical incidents, loss or theft, etc.

The financial intermediary is a bank, a private company, etc.

The present invention can also be used by companies for recharging the payment cards for the professional expenses of its employees: the company makes available to its employees a set of nominative prepaid payment cards and a expenses/requirements function of each implements a recharging of the cards via an internet interface and the recharge numbers (coupons). The employees thus have available the necessary funds for their professional expenses.

With reference to FIG. 7, the company 700 credits (702) its own account from which will be deducted the professional expenses of the employees of a predefined amount that it authorizes as expense for the employee with his prepaid payment card. The company so informs (704) its bank which transmits the information to the Visa/MasterCard (trademarks) interbank network. The payment cards of the beneficiaries are credited (706) by the predefined amount from bank to bank on the interbank network.

At the end of the chain, the employees (708) can use their prepaid bank cards on their business trips.

FIG. 8 illustrates the use of the present invention in the context of money transfer.

The clients purchase (800) coupons of a value of X euros and telephone (802) the recharge management server. The financial intermediary's platform verifies the status of the coupons and payment card to be recharged then sends the request for crediting the payment card (804). This request disseminates the information on the entire interbank network and credits the card held, e.g., by a family member at the other end of the globe (806). This person can then spend the X euros in his country by the intermediary of the payment card.

The present invention can also apply to concepts such as telephone and electricity bills.

1. Payment method by prepaid bankcard provided by a financial intermediary of a transaction with a merchant comprising:
a step of transmission to a management server by the merchant's bank server of a request comprising at least the amount of the transaction and an identifier of the bankcard, said transmission being implemented via the intermediary's bank server;
a step of verification and modification of the status of the account associated with the bankcard identifier by the management server, this server comprising a database of the bankcard identifiers and the balance status of the accounts associated with said bank cards;
a step of transmission of the payment authorization to said merchant (EPT or automated dispensing machine);
recharging steps consisting of modifying on the management server the information relative to the available balance of the bankcard holder;
characterized in that
recharging is implemented via the intermediary of a prepaid coupon with which is associated a unique identification number and to which corresponds a predefined amount;
said management server moreover comprises a database of unique coupon numbers as well as the validity status and the value corresponding to the coupons;
and in which said recharging steps comprise:
a step of transmission of said coupon identifier and said bankcard identifier to said management server;
a step of verification by said management server of the validity of the received coupon identifier;
a step of determination of the numeric value of the amount associated with the coupon;
a step of modification of the validity status of the consumed coupon;
a step of updating the account balance of said bankcard.

2. Payment method according to claim 1, characterized in that said recharging steps moreover comprise, subsequent to said step of updating the account balance, a step of updating in the interbank network to which the prepaid bankcard belongs the available balance for said recharged bankcard.

3. Payment method according to claim 1 or 2, characterized in that said financial intermediary has available a bank account on said intermediary's bank server
and in that said method furthermore comprises:
a step of selling at least one coupon;
a step of crediting on said bank account the amount of the sold coupons;
a step of periodic debiting from said bank account of the amounts paid by the bankcards provided by said financial intermediary.

4. Payment method according to one of claims 1 to 3, characterized in that said step of transmission of said coupon identifier and said bankcard identifier to said management server is implemented via the intermediary of an interactive voice server.

5. Payment method according to claim 4, characterized in that the transmission of said coupon identifier and/or said bankcard identifier to said voice server is a sound transmission.

6. Payment method according to claim 4, characterized in that the transmission of said coupon identifier and/or said bankcard identifier to said voice server consists of inputting the digits constituting the unique identifier of the coupon and/or the bankcard.

7. Payment method according to one of claims 1 to 3, characterized in that said step of transmission of said coupon identifier and said bankcard identifier to said management server is implemented by the intermediary of a secure internet site.

8. Recharge coupon for the implementation of the method according to any one of the preceding claims, characterized in that it comprises a unique identification number and covering means to be scratched off that hide said unique number.

9. Recharge coupon according to the preceding claim, characterized in that it moreover comprises means for the sound transmission of said unique number.

10. Recharge coupon according to claim 8 or 9, characterized in that said number comprises between 10 and 16 digits.

11. Payment system by prepaid bankcard for the implementation of the method according to any one of claims 1 to 7, comprising:
an international interbank network comprising a multiplicity of terminals;
a multiplicity of prepaid bankcards provided by a financial intermediary and belonging to said interbank network;
a multiplicity of prepaid coupons for recharging said bankcards according to one of claims 8 to 10;
a management server of said financial intermediary, said management server comprising a database of the unique coupon numbers as well as the validity status and the corresponding value of the coupons, and a database of the bankcard identifiers and the status of the available balance of the associated bankcards;
a bank server connected to the interbank network and to the management server, said bank server comprising a bank account of said financial intermediary credited by the amount of the coupons sold and debited periodically from the amounts paid by said payment cards.

12. Payment system according to the preceding claim, characterized in that it furthermore comprises a voice server connected to said management server and by which the user wishing to recharge his prepaid bankcard transmits the unique identifiers of his bankcard and the recharge coupon.

13. Payment system according to claim 11, characterized in that it furthermore comprises an internet server connected to said management server and housing a secure internet site capable of implementing the operations of transmission of the unique identifiers of a prepaid bankcard and of a recharge coupon for the effective recharging of said bankcard.
